(19) United States
(12) Patent Application Publication
(10) Pub. No.: US 2014/0187451 A1
(43) Pub. Date: Jul. 3, 2014

(54) Producing Nanostructure of Polymeric Core-Shell to Intelligent Control solubility of Hidrophilic Polymer during Polymer Flooding Process

(71) Applicants: Yousef Tamsilian, Tehran (IR); Ahmad Ramazani Saadatabadi, Tehran (IR)

(72) Inventors: Yousef Tamsilian, Tehran (IR); Ahmad Ramazani Saadatabadi, Tehran (IR)

(21) Appl. No.: 13/730,938

(22) Filed: Dec. 29, 2012

(51) Int. Cl. C09K 8/588

(52) U.S. Cl. CPC C09K 8/588
USPC 507/213; 507/219; 507/225; 507/226

(57) ABSTRACT

Hydrophilic polymer particles have been obtained using polyacrylamide, xanthane, maleic anhydride polymers, allylamine, ethyleneimine, and oxazoline as core polymers. Then, hydrophobic polymers shells have been produced on the core-side using styrene, styrene copolymers, polyvinyl state, polysolfune, polymethyl methacrylate, and polycyclohxyl methacrylate by in-situ polymerization of monomer as method one and inverse emulsion process as method two. These particles can release hydrophilic polymers at oil-water interface at the reservoir temperature where the water flooding should have the maximum viscosity. So, active materials cause to decrease the mobility ratio of water to oil in the reservoirs and on the other hand, plug the swept porosities and prevent to act the water fingering process.

### FIELD OF THE INVENTION

The core-shell structures using two difference polymers have various applications such as coating of natural polymers, important drugs, nutrition materials to controlled pasture, flammable substances, and also agronomy industry. It is found that this structure is applied for intelligent and controlled release in any technologies.

### BACKGROUND OF INVENTION

Oil recovery operation, practically divides into 3 steps. These steps describe the production of a reservoir in special time arrange toward each other. Naturally, the primary production is outcome of the oil shift by self-energy which exists in a reservoir. After finishing of primary remove, there is major part of oil in the reservoir, for more removal of the oil, the secondary step of oil removal is done. In this step, a fluid (immiscible gas or water) from outside of the reservoir which is supplied for producing the propulsion of remained oil is injected into the reservoirs. This fluid is injected from injection well into reservoirs and drives oil toward productive wells, but because heterogeneous of reservoirs stone, the efficiency of sweeping is low, and after some moments, the major part of productive fluids is the injected fluid which is non-economic. Therefore, by relying on third way of removal; it is found to increase oil recovery from reservoirs.

Stage of increasing oil recovery is the outcome of using gaseous or liquid chemical fluids and thermal energy. Hydrocarbon gases, carbon dioxide, nitrogen and flue gases from burning process are gases which are used in enhanced oil recovery processes, and also some liquid chemicals which are used in this process are polymers solutions, surface active agents and hydrocarbon solvents. In other hand, thermal processes, using steam or hot water, are done by relying on thermal energy which produced by the burning of oil in reservoir rocks.

As it was mentioned before, one method of increasing oil recovery from a reservoir is flooding it with water. The water flooding is developed for homogeneous reservoirs, but when a reservoir is heterogeneous (cracks, layers with different permeability); injected water looks for less resistant way to pass ways with high permeability and moves toward productive well. So, the oil which exists in high permeability ways is produced and oil of surrounded areas which have low permeability remains intact. According to this subject, high volume of oil after water flooding remains in the reservoir. Thus, if a fractured reservoir becomes candidate for the water injection, to improve efficiency and increase the percentage of recovery, we have to use alternative methods which improve the flooding procedure.

In order to extract the remaining oil after water flooding, some techniques were developed that one of them is flooding with a polymer solution. The use of polymers in injection water is more costly, however, if the proceeds from the recovery will be further considered, finally flooding with polymer solutions will be more economical.

Initial researches were done by Datling to modify sweep efficiency via water flooding process during 1944 to 1958. He had added some polymer solutions to oil recovery mixture to enhance water viscosity that fortunately, succeed to reach technical approaches. Due to the low cost of water-soluble polymers, these polymers were preferred than other polymers, finally, the results of field and laboratory tests were done between 1966 and 1972 to make the development of polymer injection as an enhanced oil recovery method possible.

As the oil recovery process involves injecting a fluid or more fluids in a reservoir. The injecting fluid is added to the natural energy of a reservoir to move oil toward productive well. In addition, injecting fluid interacts with oil-rock system of the reservoir and provides ideal conditions for the enhanced oil recovery. These interactions may result in less surface tension, expansion of oil, increasing water viscosity, and correct wetability. Generally, behavioral interactions are attributing to physical and chemical mechanisms or production of the thermal energy.

Littmann showed that polyacrylamide and hydrolyzed polyacrylamide solutions in water can modify the mobility ratio of water to oil due to injected water viscosity enhancement. So, they can be more oil than water alone mode to move in underground reservoirs.

In 2003, Green and Willhite showed that blocking of undesirable passes and penetration reducing in the mentioned situations is other effects of synthesized polymers such as hydrolyzed polyacrylamide in enhance oil recovery (EOR) process. In other words, these polymers can be absorbed on swept surfaces, cause to detour injected solutions to non-swept paths. It is great effect of injected polymers to enhance oil recovery.

According to the polymer flooding, several studies were done to investigate influence of polymer solutions in rheological properties and oil recovery process. Study of significant parameters for polymer absorption, unpredictable problems for formation of the related gel in wells, simulation of polymer solution flow in considerable path, and polymer resistance against environmental parameters are considered subjects for most researchers in oil recovery issue. However, in according to study of Yang, there are many limitations with the existing polymer flooding technologies such as thermal, mechanical, shear, and biological degradations of polymer chains during flooding process.

Many works have been done to overcome the above mentioned limitation in the polymer flooding method with polyacrylamide solutions such as copolymerization of acrylamide monomer with more resistant monomers. However, these approaches can only partially solve problem relating to the stability and absorption of polymers on capillary surfaces. So, more sophisticated method could be appreciated.

Recently, based on studies of Fan, Reis, Couvreur, and Dubernet, encapsulation has been considered as a sophisticated approach for protection and controlled release of precious materials in many fields. It is worth noting that drug delivery study is one of the advanced technologies in this case. In this way, coating materials and revolute technologies are developing to help these intellectual technologies.

During two decays ago, stable systems and controlled transport of concerned materials in different fields are developed until the mentioned developments can present medicine production with high ability to support human health by controlled release system. Nano and micro particles of polymers and copolymers are most famous coating in transfer systems. In addition, Fan, Reis, Couvreur, and Dubernet showed that intelligent and time dependent release procedure causes to modify the effects of material and save money in the oil recovery process.

Due to difficulties of polymer flooding and possible solutions to reduce the potential of its physical and chemical damage, this invention is trying to apply intelligent methods of coating polymers, design and preparation of a restoring systems is done to transfer hydrophilic polymers in the reservoir to special points in the reservoir to protect from problems that polymer maybe cause by gel condensation in the way that not considered, and by increasing the viscosity of water in certain areas to enhance efficiency of oil recovery. In this regard, by study the methods of coating and polymerization methods and agents that cause using of coatings, reaching to important goals in enhanced oil recovery for using hydrophilic polymer nanoparticles with intelligent nanoscale coating are considered in on time delivering in determined areas.

### SUMMARY OF INVENTION

In this study, a novel core-shell structure of hydrophilic polymer as an active polymer and nanoscale coating hydrophobic polymer as a shell polymer was designed and prepared to intelligently control mobility ratio in oil reservoirs and overcome weakness and limitations of classical polymer flooding such as high pressure drop, plugging, surface absorption, thermal, mechanical, and bacterial degradation.

Two methods were used: 1. in-situ polymerization of monomer as hydrophobic media on core-side of the hydrophilic polymer, and 2. inverse emulsion polymerization to synthesize high molecular weight core polymer and low molecular weight shell polymer as intelligent coat as hydrophobic media, which was approached for oil fields. This intelligent structure releases active polymer in oil-water interface after dissolution of polymeric coat in the oil phase which could result in dramatically increase of the water viscosity in the interface. This process hindered fingering phenomena in oil reservoirs using much less polymer in comparison to the classical polymer flooding process.

To optimize experimental conditions for preparation of nanocoated particle, different statistical methods including Response Surface Methodology (RSM), Average Effects pht, Taguchi and optimization genetic algorithm, were used. Morphological, chemical, thermal properties of produced core-shell nanoparticles were investigated using scanning electron microscopy (SEM) images, Infra-Red (IR); Nuclear Magnetic Resonance (NMR); Energy-Dispersive X-ray (EDX); Ultraviolet (UV) spectroscopy, and Differential Scanning Calorimetry (DSC), respectively. These results revealed a core-shell structure for produced particles with considerable interaction of two polymers, having average core and shell diameters of 90 and 25 nm, respectively.

Using optimized conditions for the preparation of core-shell structure resulted in preparation of completely coated hydrophilic polymer particles with hydrophobic polymer which has been confirmed by Infra-Red results. Furthermore, the hydrophilic polymer release potential from the mentioned system in oil-water mixture was investigated at high temperature (90° C.) by dissolution experiments at simulated reservoirs conditions and micromodel flooding experiments.

Release rate of active polymer from core-shell particles in water/oil mixture has been studied by intrinsic viscosity measurements using Ubbelohde viscometer. The obtained results show that this system has necessary ability for carrying active polymer at oil-water interface in the oil reservoir and releasing it in the front water. Dissolution and micromodel polymer flooding experiments revealed that releasing time and sweep efficiency of the polymer increase and energy consumption during flooding process diminishes dramatically using the novel core-shell structure. Micromodel flooding experiments show that using core-shell structure can reduce usage of polymer by one-third of the initial value for obtaining the same recovery factor in classical polymer flooding.

### BRIEF DESCRIPTION OF THE FIGURES

FIG. 1 shows the polymeric nanoparticle with nanoscale coating to control solubility of core polymer during polymer flooding process.

FIG. 2 shows the water flooding process (a) and the intelligent polymer flooding process (b).

FIG. 3 shows operation process chart (OPC) to produce polymeric nanoparticle with nanoscale coating.

FIG. 4 shows effects of kinetics conditions of reaction environment.

FIG. 5 shows the produced nanoparticles with polymeric nanoscale coating.

FIG. 6 shows classification of the considered tests to investigate identification of the produced nanoparticles with polymeric nanoscale coating.

### DETAILED DESCRIPTION OF THE PREFERRED EMBODIMENT

According to the control systems of material transfer which have different kinds and classifications and on the basic of different mechanisms that material release process has done by them, by studying coating and encapsulation systems and the release of material from coating particles, this invention improves the polymer process with the encapsulation operation by using suitable polymers for coating the main materials which is used for increasing water viscosity and best methods for the polymerization of core and shell polymers.

In order to enhance oil recovery and the encapsulation operation of polymer flooding process, we tried that by developed studies on encapsulating systems and identification different kind of these systems, evaluating their weaknesses and strength and according to these information, the best intelligent method is selected. In other hand, by accurate identification of polymer flooding and encapsulating process, we tried to benefit from the advantages of these two processes in increasing oil recovery. By thinking about coating and encapsulating processes, we found that by combination of these two processes in synthesizing polymer coating particles, the efficiency of oil recovery can increase by using the advantages of these two methods.

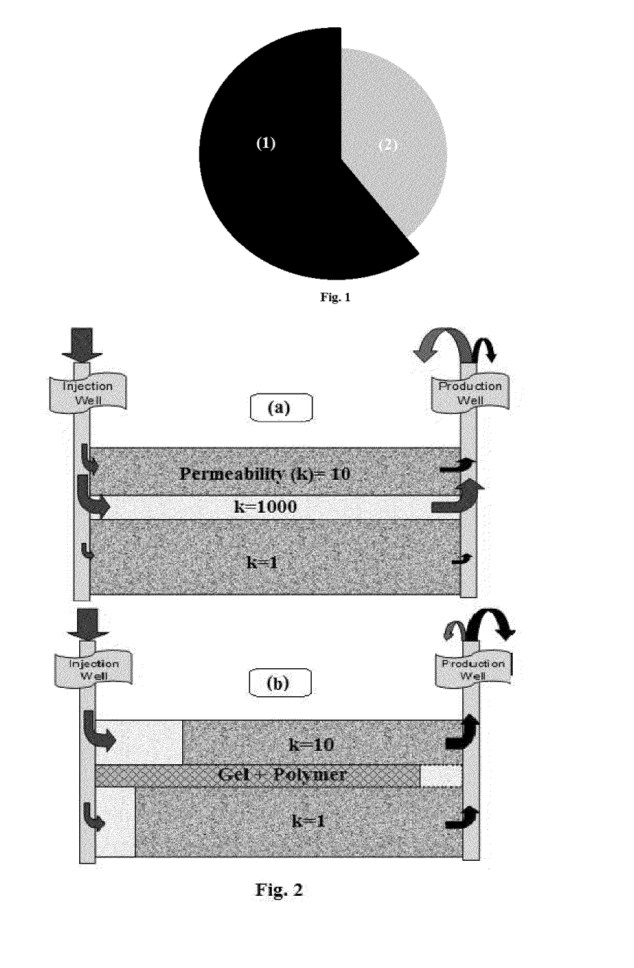

According to FIG. 1, these invented nanoparticles consists of two parts, core 1 and shell 2 with polymer commodity in nanoscale. The core is hydrophilic polymer and its coating is hydrophobic polymer. FIG. 2 shows the effect of these polymer particles in the oil reservoir. In part (a) of FIG. 2, enhanced oil recovery process is done just by water. In this process, after moving water fluid with low viscosity and high mobility ratio than oil into productive well, the oil of other areas remains intact, and just in productive wells; water is produced instead of oil.

In part (b) of FIG. 2, enhanced oil recovery is done by mixing of water and constructed polymer particles. By moving these particles into oil reservoirs, the polymer coating solves in the oil and thus released core polymer in water and causes the increasing of water viscosity. Therefore, the increasing of water viscosity causes the decrease of water mobility ratio than underground oil and increases the efficiency of oil removal.

So, the new polymeric core-shell nanostructure which is used in enhanced oil recovery process has two main roles during the process:

1. The presence of nanolayer as shell on the polymeric core prevents from bacterial, physical, thermal degredables and gel condensation in undesirable areas and causes direct effect of the polymer solution in determined areas to enhance oil recovery.

2. Specified and intelligent release of active polymers in depths of oil wells, additionally of direct effect on special areas, causes the remaining of coating particles potentially in depth of well, and after moving next slag of water fluid, effects its mobility and done its function. This case causes remarkable economic saving in using active polymers.

### Method One

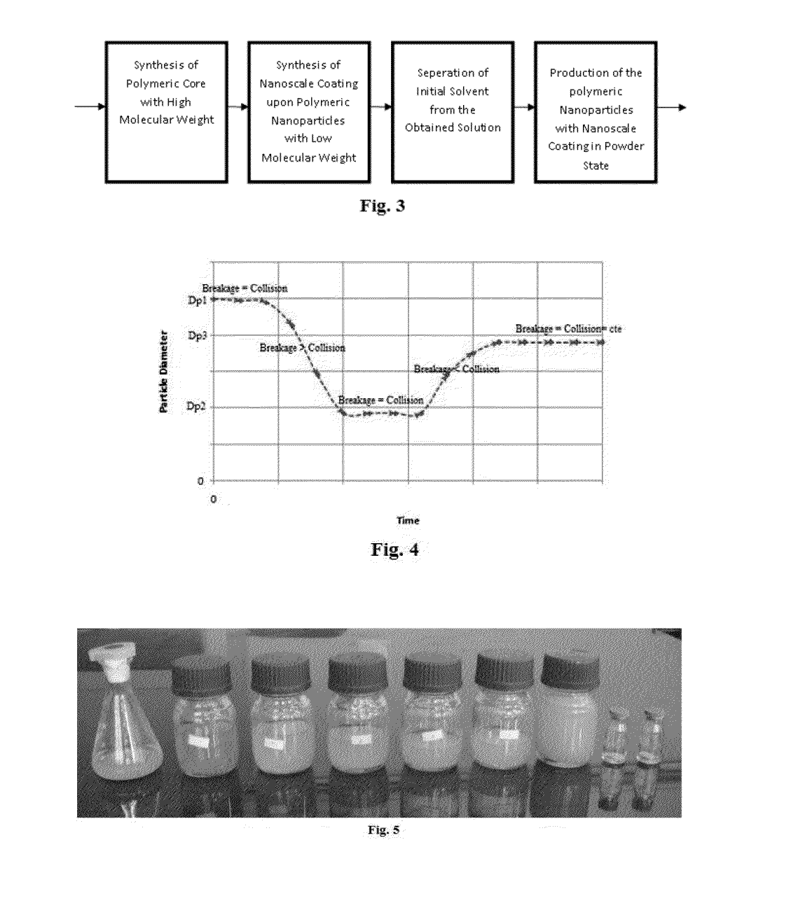

The steps of producing hydrophilic nanoparticles with intelligent nanoscale coating are shown in FIG. 3. In this field, inventors consider synthesis of polymer nanoparticles with high and low molecular weights of core polymer and nanoscale coating in the reaction environment, respectively. According to earlier studies for selecting best method of the polymerization, the inverse emulsion is selected as best method because of its correspondence to special goals.

This method because of its dominant mechanism, provides the possibility of making core polymer nanoparticles with polymeric nanoscale coatings in 4 steps: the first step is making active polymer as core portion which comprises of water, monomer of making hydrophilic polymer, initiator (potassium persulfate-Iron (II) and sulphate-7H₂O, potassium persulphate, benzoyl peroxide), organic solvent (hexane), surfactant (Span, sodium dodecyl sulfate (SDS).

First, the solvent and surfactant with specific volume are mixed in the reactor. After mixing, water solution, including hydrophilic monomer and specific volume of water, disperse in the reactor controlling the core size and their scattering are important. As the selected method is inverse emulsion and polymerization process is done in water phase, so all the effective parameters in water phase which is in distributed phase, cause the making of smaller particles. So, specific parameters and simultaneous processes play an important role in making particles with nanoscale size.

In other hand, generally there are two parameters which interfere in the particle size in an emulsion system: breakage and collision. Thus, operation (temperature, mass scale of scatter phase, effective parameters on interaction speed) and process conditions (the method of injection of scatter phase, and the speed of mechanical mixer) have remarkable effect on the mentioned parameters.

For example, as the temperature has remarkable effect in environmental conditions, so it is found to predict three advantages for decreasing the temperature (FIG. 4):
The initiator like redox (potassium persulfate-Iron (II) and sulphate-7H₂O) has better function in low temperature, but potassium persulphate needs high temperature.
Decreasing temperature causes better control of the reaction and decreasing the speed of it. Thus the polymeric radicals are more resistant and the polymerization operation is done better.
Decreasing the temperature causes solvent phase (hexane) lock off more simple.

According to FIG. 4, in different periods of a reaction, two parameters (collision and breakage of particles) have remarkable effects on final size of particles. One effective parameter in making nanoparticles is producing high mechanical stress (breakage conditions). Using a mechanical mixer with high speed, a homogenizer, and a mechanical mixer with a sonicitor simultaneously for making local stress and scattering, are considered as efficient ideas in this invention.

After mixing of organic and water phases, the initiator is injected to the mixture and the polymerization process (making active polymer chain) starts. The time of polymerization is different depending on desirable molecular weight and polymerization mechanism. Therefore, if polyacrylamide monomer is candidate for producing active polymer, the mechanism becomes radical dominant.

In this way, there are three steps: initiation, paropagation, and termination in the radical mechanism, that propagation step is very important. In other hand, the radicals of acrylamide by injecting initiator, have short life time, thus in first minutes of injecting initiator, 60-70% of polymerization operation is done and just few of radicals survive, and it is possible to improve their life time by controlling temperature, and N₂ purging to increase the polymer chain length.

In the second step of the process, the initiator of second step and monomer of organic polymer should be injected for making nanoscale coating. In this step, at first, the initiators must be injected which have opportunity to coat the nanoparticles of core, but as the time of making the radicals by the initiator is short (lower than 0.0001 seconds), organic monomers and the initiator of the second step must be injected simultaneously and the initiators on surface of polymer nanoparticle of core cause making the chain from the organic polymer and this chain is elongated continuously. One of the novelty views of this invention is the selecting best kind of initiators for the polymerization of hydrophobic monomer on nanoparticle of hydrophilic polymers.

Therefore, in this invention, some initiators are used which are soluble in water, and by attracting water molecules on core nanoparticles which are water absorption, initiators also remain on these particles because of its hydrophilic properties and become the point for starting of organic polymerization process and make a polymer coating on hydrophilic polymer nanoparticles. In this process, initiators such as redox, potassium persulphate and sodium dodecyl sulfate (SDS) are desirable candidates for coating polymerization, but according to required kinetic conditions, redox initiator has been preferred.

One of the goals of this invention is to make a layer of organic polymer on particles, the operation of chain transfer must be done in specific time and prevent from extra propagation of polymer chain. This case is because by entering particles into the underground reservoirs, the coating layer solves in the organic phase and the operation of active polymer release is done in the best conditions.

As mentioned before, shell polymer solves in the organic solvent, so the used solvent should be removed from the reactor at final step of the reaction until it does not cause the tenacity of particle and changing their diameters. This separation is done by mixing and then centrifuge operation that the time and speed of mixing operation and centrifuge operation have important roles in total separation of organic solvent (third steps). After centrifuge and separation of synthesized particles, the goal is providing the constructed particle as powders. So, water should be removed from suspension solvent and the dried particles become useable as powders in oil reservoirs that this process is done by freeze drying.

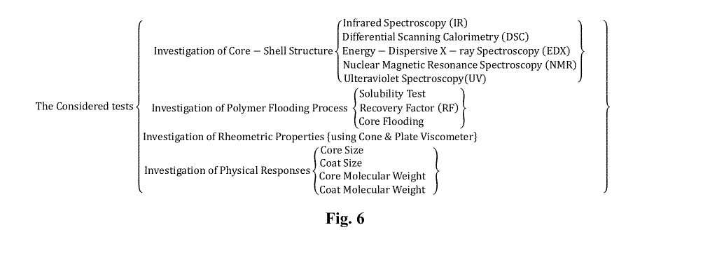

Finally, the powder particles have the core-shell structure that its core is hydrophilic polymer nanoparticle with high molecular weight and its shell is organic polymer monolayer with low molecular weight. FIG. 5 shows the core-shell nanostructure in accordance with one of the process conditions. FIG. 6 shows the classification of tests which are considered to identify particles properties for this invention.

At first, the coating layer of polymer nanoparticle is evaluated. There are different methods to identify these two materials from each other in produced particles such as IR, DSC, NMR, and EDX images that the results show the successful coating of hydrophilic polymer nanoparticles by organic polymeric nanoparticles.

After identification of produced materials, the effects of the product in enhanced oil recovery process are evaluated. The results of testing constructed materials in enhanced oil recovery process show that according to the release of encapsulated particles, the transfer of these particles to more depth areas of oil reservoirs can be done with more success, and the release of these particles are not done before target points, and this nanoscale coating is able to protect the polymer particles from damages.

In other hand, by using encapsulation process for hydrophilic polymer particles and using them in polymer flooding, the enhancement of efficiency in polymer flooding is expected. This is because particles in leaded paths cause the increase of water viscosity. Thus, according to the results from testing the percentage of oil recovery in the core-shell nanostructure flooding process than classic polymer flooding with using low percentage of active polymers, the similar percentage of oil recovery in the flooding by pure polymer has been seen.

At last, by studying the size and molecular weight of the core and to shell of polymers by using reliable test methods for measuring them, size and molecular weight of core and shell polymers has been arranged in desirables quantities. This can be followed in tables below.

Table 1 shows the properties of produced particles and Table 2 indicates the kinds of polymers which can be used in this invention.

TABLE 1
Core-shell nanostructure specifications in this invention

| Properties | Range |
|---|---|
| Molecular Weight of Polymeric | 6,000,000-80,000,000 |
| Core | |
| Molecular Weight of Polymeric | >60,000 |
| Layer | |
| Core Size (nm) | <90 |
| Coating Size (nm) | <25 |
| Release Time (day) | >21 |
| Recovery Factor (%) | >50 |
| Viscosity (Pa · S) @ shear | ~4 |
| rate = 0.01 (1/s) | |
| Viscosity (Pa · S) @ shear | ~0.09 |
| rate = 100 (1/s) | |
| Shear (Pa) @ shear rate = | ~0.02 |
| 0.01 (1/s) | |
| Shear (Pa) @ shear rate = | ~8 |
| 100 (1/s) | |
| Specific Viscosity (Pa · S) @ | ~3 |
| Angular Frequency = 0.1 (1/s) | |
| Specific Viscosity (Pa · S) @ | ~0.2 |
| Angular Frequency = 100 (1/s) | |
| Storage Module, G′ (Pa) @ | ~0.2 |
| Angular Frequency = 0.1 (1/s) | |
| Storage Module, G′ (Pa) @ | ~500 |
| Angular Frequency = 100 (1/s) | |
| Loss Module, G″ (Pa) @ | ~0.2 |
| Angular Frequency = 0.1 (1/s) | |
| Loss Module, G″ (Pa) @ | ~100 |
| Angular Frequency = 100 (1/s) | |
| Water soluble Initiator | 2,2′-Azobis[2-(2-imidazolin-2- |
| | yl)propane]dihydrochloride |
| | 2,2′-Azobis[2-(2-imidazolin-2- |
| | yl)propane]disulfate dihydrate |
| | 2,2′-Azobis(2- |
| | methylpropionamidine)dihydrochloride |
| | 2,2′-Azobis[N-(2-carboxyethyl)-2- |
| | methylpropionamidine]hydrate |
| | 2,2′-Azobis{2-[1-(2-hydroxyethyl)- |
| | 2-imidazolin-2-yl]propane}dihydro- |
| | chloride |
| | 2,2′-Azobis[2-(2-imidazolin-2- |
| | yl)propane] |
| | 2,2′-Azobis(1-imino-1-pyrrolidino-2- |
| | ethylpropane)dihydrochloride |
| | 2,2′-Azobis{2-methyl-N-[1,1- |
| | bis(hydroxymethyl)-2-hydroxy- |
| | ethl]propionamide} |
| | 2,2′-Azobis[2-methyl-N-(2- |
| | hydroxyethyl)propionamide] |
| | Potassium persulfate-Iron(II) |
| | sulfate•7H₂O |
| | Potassium persulfate |
| | Benzoyl peroxide |
| Organic Solvent | Benzene; carbon tetrachloride; |
| | chlorobenzene; cyclohexane; |
| | heptane; hexane; pentane; |
| | toluene; triethyl amine |
| Surfactant | Span 30 |
| | Span 40 |
| | Span 80 |
| | Sodium Dodecyl Sulfate (SDS) |

TABLE 2
Useable polymers as core and shell polymers

| Group | Polymer of Core | Group | Polymer of Shell |
|---|---|---|---|
| Acrylamides | Polyacrylamide | Acrylate Polymers | Poly(butyl acrylate) solution in |
| | | | toluene |
| | Poly(2-acrylamido-2-methyl-1- | | Poly(ethyl acrylate) solution in |
| | propanesulfonic acid-co-acrylonitrile) | | toluene |
| | acrylonitrile | | |
| | Poly(N-isopropylacrylamide) | | Poly(2-ethylhexyl acrylate) solution |
| | | | in toluene |
| | Poly(N-isopropylacrylamide), | | Poly(methyl acrylate) solution |
| | carboxylic acid terminated | | |
| | Poly(N-isopropylacrylamide), | | Poly(methyl acrylate), azide |
| | maleimide terminated | | terminated |
| | Poly(N-isopropylacrylamide-co- | Acrylonitrile Polymers | Polyacrylonitrile |
| | methacrylic acid) 10 mol % in | and Copolymers | |
| | methacrylic acid | | |
| Acrylates | Poly(acrylic acid) | | Poly(acrylonitrile-co-methyl acrylate) |
| | | | acrylonitrile |
| | Poly(acrylic acid) partial sodium salt | Maleic Anhydride | Poly(maleic anhydride-alt-1- |
| | solution | Copolymers | octadecene) |
| | Poly(acrylic acid-co-maleic acid) | | Poly(styrene-co-maleic anhydride), |
| | solution | | partial cyclohexyl/isopropyl ester, |
| | | | cumene terminated |
| Maleic Anhydride | Poly(ethylene-alt-maleic anhydride) | | Poly(styrene-co-maleic anhydride), |
| Copolymers | | | partial isooctyl ester, cumene |
| | | | terminated |
| | Poly(isobutylene-co-maleic acid) | | Poly(styrene-co-maleic anhydride), |
| | sodium salt cross-linked | | partial propyl ester, cumene |
| | | | terminated |
| | Poly(methyl vinyl ether-alt-maleic acid) | Methacrylate Polymers | Poly(benzyl methacrylate) |
| | Poly(styrene-alt-maleic acid) sodium | | Poly(butyl methacrylate) |
| | salt solution | | |
| Methacrylate, | Poly(2-dimethylamino)ethyl | | Poly(tert-butyl methacrylate) |
| Ethacrylate, and | methacrylate) methyl chloride | | |
| Related Polymers | quaternary salt | | |
| | Poly(2-ethylacrylic acid) | | Poly(butyl methacrylate-co-isobutyl |
| | | | methacrylate) |
| | Poly(2-hydroxyethyl methacrylate) | | Poly(butyl methacrylate-co-methyl |
| | | | methacrylate) |
| | Poly(2-propylacrylic acid) | | Poly(cyclohexyl methacrylate) |
| Amine-Functional | Cucurbit[5]uril hydrate contains acid of | | Poly(ethyl methacrylate) |
| Polymers | crystalization | | |
| | Polyethylenimine, 80% ethoxylated | | Poly(ethyl methacrylate) |
| | solution 37 wt. % in H2O | | |
| | Poly(2-ethyl-2-oxazoline) | | Poly(hexadecyl methacrylate) |
| | | | solution in toluene |
| Ethers | 2-Dodecenylsuccinic polyglyceride | | Poly(hexyl methacrylate) solution |
| | Glycerol propoxylate | | Poly(isobutyl methacrylate) |
| | Polyepoxysuccinic acid | | Poly(isobutyl methacrylate) |
| | Poly(methyl vinyl ether) solution 50 wt. | | Poly(isopropyl methacrylate) |
| | % in H2O | | |
| Polystyrenesulfonate | Polyanetholesulfonic acid sodium salt | | Poly(lauryl methacrylate-co-ethylene |
| and Related Polymers | | | glycol dimethacrylate) |
| | Poly(sodium 4-styrenesulfonate) | | Poly(methyl methacrylate) |
| | Poly(4-styrenesulfonic acid) | | Poly(tetrahydrofurfuryl methacrylate) |
| | Poly(4-styrenesulfonic acid-co-maleic | Amides and Imides | Poly[N,N′-(1,3- |
| | acid) sodium salt | | phenylene)isophthalamide] |
| Vinyl Acids | Poly(vinylphosphonic acid) | | Polymaleimide |
| | Poly(vinyl sulfate) potassium salt | Carbonates | Poly(Bisphenol A carbonate) |
| | Poly(vinylsulfonic acid, sodium salt) | | Poly(propylene carbonate) |
| | solution 25 wt. % in H2O | | |
| Vinyl Alcohols | Poly(vinyl alcohol), 99+% hydrolyzed | Dienes | Poly(acrylonitrile-co-butadiene) |
| | | | acrylonitrile 37-39 wt. % |
| | Polyvinyl alcohol boric acid | | Polybutadiene |
| | Poly(vinyl alcohol-co-ethylene) | | Polybutadiene, hydroxyl terminated |
| | ethylene | | |
| | | | Polyisoprene |
| | | | Poly(styrene-co-butadiene) styrene |
| | | | 45 wt. % |
| | | Esters | Poly(1,4-butylene adipate) |
| | | | Poly(1,4-butylene succinate), |
| | | | extended with 1,6- |
| | | | diisocyanatohexane |
| | | | Poly(1,4-butylene terephthalate) |
| | | | Poly[di(ethylene glycol) adipate] |
| | | | Poly(ethylene terephthalate) |
| | | | Poly[trimethylolpropane/di(propylene |
| | | | glycol)-alt-adipic acid/phthalic |
| | | | anhydride], polyol |
| | | Fluorocarbons | Poly(chlorotrifluoroethylene) |
| | | | Poly(hexafluoropropylene oxide) |
| | | | Poly(tetrafluoroethylene) |
| | | | Poly(vinylidene fluoride) |
| | | | Poly(vinylidene fluoride-co- |
| | | | hexafluoropropylene) |
| | | Olefins | Polybutenes |
| | | | Poly(1-decene) |
| | | | Poly(dicyclopentadiene-co-p-cresol) |
| | | | Poly(4-methyl-1-pentene) |
| | | | Polyisobutylene |
| | | | Polyethylene |
| | | | Poly(ethylene-co-acrylic acid) |
| | | | Poly(ethylene-co-glycidyl |
| | | | methacrylate) |
| | | | Polyethylene monoalcohol |
| | | | Polypropylene |
| | | | Poly(propylene-co-1-butene) |
| | | Styrenes | Polystyrene |
| | | | Polystyrene, monocarboxy |
| | | | terminated |
| | | | Poly(styrene-co-acrylonitrile) |
| | | | Poly(styrene-co-allyl alcohol) |
| | | | Poly(styrene-co-4-bromostyrene-co- |
| | | | divinylbenzene) |
| | | | Poly(styrene-co-chloromethylstyrene) |
| | | | Poly(styrene-co-maleic acid) |
| | | | Poly(styrene-alt-maleic anhydride) |
| | | | Poly(styrene-co-methacrylic acid |
| | | | Poly(styrene-co-α-methylstyrene) |
| | | | Poly(styrene-co-methyl |
| | | | methacrylate) |
| | | | Polyacenaphthylene |
| | | | Poly(4-bromostyrene) |
| | | | Poly(2,6-dichlorostyrene) |
| | | | Poly(4-methylstyrene) |
| | | | Polyvinylcyclohexane |
| | | | Poly(4-vinylphenol) |
| | | | Poly(4-vinylphenol-co-methyl |
| | | | methacrylate) |
| | | Vinyl Acetals | Poly(vinyl butyral-co-vinyl alcohol- |
| | | | co-vinyl acetate) |
| | | | Poly(vinyl formal) |
| | | Vinyl and Vinylidene | Poly(vinyl chloride) |
| | | Chlorides | Poly(vinyl chloride-co-vinyl acetate) |
| | | | Poly(vinyl chloride-Co-vinyl acetate- |
| | | | co-vinyl alcohol) |
| | | | Poly(vinylidene chloride-co-methyl |
| | | | acrylate) |
| | | Vinyl Esters | Poly(vinyl acetate) |
| | | | Poly(vinyl acetate-co-butyl maleate- |
| | | | co-isobornyl acrylate) solution 50 wt. |
| | | | % in ethanol |
| | | | Poly(vinyl cinnamate) |
| | | | Poly(vinyl stearate) |
| | | Vinyl Ethers and | Poly(ethyl vinyl ether) |
| | | Ketones | Poly(isobutyl vinyl ether) |
| | | | Poly(vinyl methyl ketone) |
| | | Poly(vinylpyridine) | Poly(4-vinylpyridine) |
| | | | Poly(4-vinylpyridine-co-butyl |
| | | | methacrylate) |
| | | | Poly(4-vinylpyridine-co-styrene) |
| | | | Poly[4-vinylpyridinium |
| | | | poly(hydrogen fluoride)] |
| | | | Poly(4-vinylpyridinium p- |
| | | | toluenesulfonate) |
| | | Poly(vinylpyrrolidone) | Poly(vinylpolypyrrolidone) |
| | | | Poly(1-vinylpyrrolidone)-graft-(1- |
| | | | triacontene) flakes |

### Method Two

The second method is for coating natural polymer nanoparticles such as xanthane and prepared gels from hydrophilic polymers. At first, by using desirable polymerization process, the polymer of core is synthesized in nano-synthesized scale. For producing polymer nanoparticles as core polymers, spray drying method is used to produce solid particles from thin solvents.

In the second step, encapsulation experiment is carried out in a specific volume of a reactor. The determined volume of hydrophobic monomers, nanosized particles of hydrophilic polymer nanoparticles powder and a suitable surfactant are placed into the reactor under stirring for 1 hr under nitrogen atmosphere, and then an appropriate initiator and deionized water are added for beginning of the polymerization reaction. The process of the mixing, depend to the kind of coating polymer takes 30-300 minutes until making coating of organic polymer on constructed nanoparticles. After finishing the time of the reaction, the encapsulated particles are separated by filtering process and by passing thin fluids of free air in them and drying in a clean surface.

### Example One

At first, 60 ml of hexane solvent and 0.0035 ml of span 80 surfectant are mixed in the reactor, and after mixing those by using a mechanical mixer with speed around 2000 rpm, the water phase, including 5 gr hydrophilic monomer of acrylamide and 20 ml of water, is distributed to the previous solution. It should be noticed that the distributing process of water phase is one of the important parameters which affects the size of core particles. So, the water phase is injected to the mixed organic phase in the reactor via a microinjection.

This case helps in making emulsion of polymer nanoparticles. After the mixing water and organic phases, the initiator system (redox), including ferrous sulfate and potassium persulfate, is injected with weight 0.001688 gr and 0.000725 gr, respectively in temperature condition −15° C., by entering this material into the reactor. The first time period of polymerization is selected that the reactor remains under mentioned conditions for 30 minutes and after that immediately is moved to the very low temperature condition for 3 or 4 days. After this time, nanoparticles of polyacrylamide with high molecular weight are produced and are the time to inject the second initiator and monomer of nanolayer. Therefore, in second steps of the process, the redox initiator in low temperature condition (−15° C.) and styrene monomer are injected for making nanocoating. It should be noticed that the initiator of second steps and the organic monomer must be injected simultaneously, and the initiator on surface of polymer nanoparticle causes making chain of polystyrene, and this chain is propagated continuously.

One of the goals is making the most small organic polymer layer on particles, the transfer of chain must be done in special time and extra propagation of polymer nanolayer chain is prevented. So, by considering short time for second polymerization process (about 30 minutes), the thin layer of polystyrene is made on nanoparticles of polyacrylamide and after this time, the reaction process is terminated.

Polystyrene layer is solved in hexane solvent, so this solvent must be removed from the reactor at final that do not cause the change of particle size and prevent from their tenacity. This separation is done by removing the materials of the reactor and centrifuging them by speed 5500 rpm for 30 minutes. After that the material are divided into 3 phases. As the bottom phase consists of pure hexane solvent with dark color, meddle phase from mid solid particles with white coating and the head phase consists of white fluids which are mixing of hexane and coating particles. The middle phase which is rich of coating nanoparticle is strew into some water and remain under high speed mixing for 3 minutes.

After that the materials are sprayed into the high level of water with high pressure. After centrifuging and separating of synthesized particles, the goal is producing the particles as powder. So, the water must be removed from the suspension solvent and the particles become useable as powder in the enhanced oil recovery that this process is done by freeze drying. In the end, the synthesized powders have core-shell nanostructure that its nanocore of polyacrylamide with 6 million Dolton (molecular weight) and its size is 80 nanometers, and its shell is nanolayer of polystyrene with 40000 Dolton (molecular weight) and its size is 10 nanometers.

For investigating the kind of release polyacrylamide from its coating and effects on rheological properties of water phase in underground reservoirs, a test is planed as the coating particles remain on oil or xylene for special period of time. In this period, after sampling, viscosity of water phase is measured via dilute viscometer. In these conditions, in contacting synthesized particles by organic phase under the temperature close to underground oil reservoirs (90° C.), their polystyrene coating solves in oil phase gradually, and the polyacrylamide molecules through the shell have an opportunity to diffuse into the water.

This case causes the release of polyacrylamide and the increase of the concentration and viscosity water. Molecular release of polyacrylamide, because of its high molecular weight required long time, and this is one of the goals on this invention that particles could move toward depth areas of oil reservoirs and remain in special fractures.

According to the special component of oil, these materials cause the inflation and solvent of polystyrene in oil phase and this causes the release of inside materials of the shell. As identified in this test for the time of release nanoparticles of polyacrylamide which coating in water phase, the total solvent of pure polyacrylamide with 6 million Dolton (molecular weight) under the temperature 90-100° C. takes 6 days, but the total release of nanoparticles of polyacrylamide from nanolayer of polystyrene and its total solvent in water phase in similar temperature condition takes 21 days.

The 3 methods of flooding for comparison the effects of processes in enhanced oil recovery are provided in Table 3.

TABLE 3
The results of 3 methods of flooding in
EOR process in accordance with method one

| | Recovery | Pore Volume |
|---|---|---|
| Enhance Oil Recovery Method | Factor % | Factor |
| Water Flooding | 44.17381 | 0.1437 |
| Polymer Flooding | 61.02884 | 0.1825 |
| Core-Shell Polymer Flooding | 61.00461 | 5.4000 |
| With Method One | | |

According to the mechanism for testing the percentage of oil recovery by intelligent flooding process, it is found, for core-shell polymer flooding with method one, that just in volume of progress deploy of the polymer, the active polymer is used and the percentage of oil recovery is relatively similar to flooding process of pure polymer. In other hand, in the flooding process with new synthesized core-shell nanostructure, just 30% of the active polymer is used compared to that of the classic polymer flooding.

### Example Two

Conventional water/oil emulsion polymerization is preceded by adding the surfactant to stabilize hydrophobic monomers in aqueous medium. But in this invention hydrophilic nanoparticles are dispersed in an organic medium; i.e. styrene monomer. Polyacrylamide is synthesized by the emulsion polymerization to reach high molecular weight (˜20 million) and then its dilute solution; it is used to produce nanoparticles through spray drying method. In the experiments deionized water, styrene monomer, potassium persulfate (KPS) as initiator, span 40 as surfactant, polyacrylamide particles and xylene are used. Styrene is treated with 1 molar NaOH aqueous solutions to remove the inhibitors and is distilled under reduced pressure with nitrogen atmosphere prior to the polymerization. All other materials are analytical grade without further purification.

Encapsulation experiment is carried out in a 250 ml, 3 necked flask. 50 ml of styrene monomer, 5 ml xylene to solve polystyrene, 0.5 gr nanosized particles of polyacrylamide and 0.01 gr Span 40 are placed into the flask under stiffing for 1 h in a nitrogen atmosphere and 50° C., and then 0.1 gr potassium persulfate (KPS) is added as an initiator and 0.5 ml of deionized water for beginning of polymerization reaction. KPS is a hydrophilic initiator and is capable of starting the polymerization of styrene monomer on the surface of polyacrylamide particles. In the experimental procedure, KPS is added after emulsification of polyacrylamide nanoparticles with styrene monomer. The reaction goes on in a nitrogen atmosphere for 3 h in 75° C. The obtained mixture is stirred at 850 rpm during the experiment. The encapsulated nanoparticles of polyacrylamide-polystyrene are achieved by filtering the mixture and then washing by ethanol. The reaction temperature is 75° C. to the reaction as an appropriate temperature to polymerization of styrene in order to get a thin film of polystyrene on the nanoparticles and best activity rage of initiator.

For evaluating the release of polyacrylamide from its coating and their rheological effects of water phase in underground reservoirs, the test is planed that the coating particles or xylene remain in oil for special time period. In this time period, in identified yields, the authors examine done the accurate viscometer test for calculating viscosity of water phase. In these conditions, in contact of produced particles with organic phase under the temperature close to underground reservoirs (90° C.), the polystyrene coating resolves in oil phase gradually, and there is the possibility of moving water into the molecules of polyacrylamide on the shell into the water and vice versa. In summary, the results of three methods for flooding process and comparing the effects of process in enhanced oil recovery by method two are listed in Table 4.

TABLE 4
The results of 3 methods of flooding in
EOR process in accordance with method one

| | Recovery | Pore Volume |
|---|---|---|
| Enhance Oil Recovery Method | Factor % | Factor |
| Water Flooding | 32.05300 | 0.1017 |
| Polymer Flooding | 54.94778 | 0.1695 |
| Core-Shell Polymer Flooding | 55.00903 | 4.2201 |
| With Method Two | | |

It is understood that the above description and drawings are illustrative of the present invention and that changes may be made in materials, ink dispensing and thermographic fixing equipment without departing from the scope of the present invention as defined in the following claims.

1. A method of producing nanostructure of polymeric core-shell to intelligent control solubility of hydrophilic polymer during polymer flooding process; comprising nanoparticles consisting of two parts, core and shell; wherein said core is hydrophilic polymer and said shell is a hydrophobic polymer; wherein said nanostructure is released inside an oil reservoir; wherein said shell is solvent in oil and said core increases water viscosity; wherein said shell dissolves in said oil reservoir and decreases water mobility ratio than underground oil in said oil reservoir and further increases efficiency of said oil in an oil removal procedure.

2. The method of claim 1, wherein said shell is anti bacterial and prevents physical and/or thermal degradation and/or gel condensation in undesirable areas in said oil reservoir.

3. The method of claim 2, wherein said shell comprises an intelligent release of said core in depths of said oil reservoir; wherein some particles of said shell remain in said depths of said oil reservoir.

4. The method of claim 3, wherein said core further comprises active polymers comprising mixed combination of water, monomer of said organic hydrophilic polymer, initiator, organic solvent and surfactant.

5. The method of claim 4, wherein said initiator comprises redox (potassium persulfate-Iron (II) and sulphate-7H₂O) and/or potassium persulphate and/or benzoyl peroxide; and wherein said organic solvent comprises hexane and wherein said surfactant comprises span and/or sodium dodecyl sulfate (SDS).

6. The method of claim 5, further comprising a polymerization process comprising step of mixing said solvent and said surfactant in a reactor; and wherein said water and said monomer are dispersed in said reactor controlling a size of said core; wherein said method is inverse emulsion and said polymerization process is performed in water phase; wherein said core particles comprise smaller particles.

7. The method of claim 6, wherein said initiator and said monomer of organic hydrophilic polymer are injected inside said reactor simultaneously.

8. The method of claim 7, wherein said core comprises high molecular weight and wherein said shell comprises organic polymer monolayer with low molecular weight; wherein size of said core is less than 90 nm and wherein size of said shell is less than 25 nm.

9. The method of claim 8, wherein said nanostructure of polymeric core-shell comprises a release time of more than 21 days and a recovery factor of more than 50%.

10. The method of claim 9, wherein said core comprises of Polyacrylamide, Poly(2-acrylamido-2-methyl-1-propanesulfonic acid-co-acrylonitrile) acrylonitrile, Poly(N-isopropylacrylamide), Poly(N-isopropylacrylamide), carboxylic acid terminated, Poly(N-isopropylacrylamide), maleimide terminated and Poly(N-isopropylacrylamide-co-methacrylic acid) 10 mol % in methacrylic acid; and wherein said shell comprises Poly(butyl acrylate) solution in toluene, Poly(ethyl acrylate) solution in toluene, Poly(2-ethylhexyl acrylate) solution in toluene, Poly(methyl acrylate) solution, Poly(methyl acrylate), azide terminated and Polyacrylonitrile.

11. The method of claim 3, wherein said core comprises natural polymer nanoparticles comprising xanthane and/or prepared gels; wherein said core is produced with a spray drying technique and wherein said hydrophobic monomers, powder of nanosized particles of said hydrophilic polymer nanoparticles and a suitable surfactant are placed inside a reactor under stirring for 1 hr under nitrogen atmosphere; and wherein an appropriate initiator and deionized water are added for beginning of a polymerization reaction.

12. The method of claim 10; wherein molecular weight of said shell is lower than 60000 Dolton.

13. Method of claim 12, wherein said nanostructure of polymeric core-shell slowly release in said reservoir and wherein said release enables said shell to reach deeper areas of said reservoir and wherein said shell protects said core from physical and mechanical damages.

14. The method of claim 13, wherein said release is 6 days for pure polycrylamide and 21 days for coated polyacrylamide polymer.

15. The method of claim 14, wherein said nanostructure of polymeric core-shell is polyacrylamide-polystyrene and wherein said polyacrylamide-polystyrene increases oil recovery up to 17% more than water flooding and comprises same recovery percentage of oil as flooding of said pure polyacrylamide.

16. The method of claim 15, wherein said initiator comprises redox, potassium persolphate, sodium didyl solphate, banzoeil perozid and kiomil peroxide.
